(19) United States
(12) Patent Application Publication
(10) Pub. No.: US 2008/0071916 A1
(43) Pub. Date: Mar. 20, 2008

(54) SYSTEM AND METHOD FOR REQUESTING A WEB SERVICE FROM A NETWORK SERVER

(75) Inventors: Chung-I Lee, Tu-Cheng (TW); Chien-Fa Yeh, Tu-Cheng (TW); Chiu-Hua Lu, Tu-Cheng (TW); Xiao-Di Fan, Shenzhen (CN); Xiao-Ping Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,880

(22) Filed: Dec. 28, 2006

(30) Foreign Application Priority Data
Sep. 20, 2006 (CN) 200610200882.1

(51) Int. Cl. G06F 15/16

(52) U.S. Cl. 709/229; 709/227

(57) ABSTRACT

A computer-based method for requesting a Web service from a network server is disclosed. The method includes the steps of: receiving a service request from a user computer; invoking a corresponding Web service from a network server; determining whether the Web service is accessible in the network server; loading configuration information of the Web service if the Web service is accessible; generating a simple object access protocol (SOAP) request according to the configuration information, and sending the SOAP request to the network server for process; collecting response information of the network server, generating processing results, creating an instance of a user-defined class, assigning the processing results to variables in the instance of the class, and returning values of the variables to a business server. A related system is also disclosed.

### BACKGROUND OF THE INVENTION

1. Field of the Invention

The present invention is related to a system and method for requesting a Web service from a network server.

2. Description of Related Art

Web service is a software system designed to support machine-to-machine interaction over a network. The definition of the Web service encompasses many different systems, but in common usage the term refers to those services that use SOAP-formatted XML envelopes and have their interfaces described by WSDL.

The Web services use the following technology: 1. extensible markup language (XML); 2. simple object access protocol (SOAP): an XML-based, extensible message envelope format, with “bindings” to underlying protocols (e.g., HTTP, SMTP and XMPP); 3. Web services description language (WSDL): an XML format that allows service interfaces to be described, along with the details of their bindings to specific protocols, typically used to generate server and client code, and for configuration.

The art of accessing network servers has been disclosed in published applications such as U.S. Pat. Pub. No. 20050210097, entitled “Method and System for Managing Programs for web services system.” This invention can be utilized to execute process operations so as to provide predetermined services and thus transmit historical information and process information. However, the disclosed applications can only be used to process simple data structures such as an array rather than complex data structures.

Therefore, what is needed is a system and method for requesting a Web service from a network server which can create an instance of a user-defined class to process complex data structures.

### SUMMARY OF THE INVENTION

A system for requesting a Web service from a network server is provided in accordance with a preferred embodiment. The system includes user computers, a business server, a control server, and network servers, the network servers being configured for storing Web services, the business server being configured for receiving a service request from the user computer and invoking a corresponding Web service from the network server. The control server includes a determining module, a loading module, a SOAP request generation module, and a response information processing module. The determining module is configured for determining whether the Web service is accessible in the network server. The loading module is configured for reading configuration information of the Web service if the Web service is accessible. The SOAP request generation module is configured for generating a simple object access protocol (SOAP) request according to the configuration information, and sending the SOAP request to the network server for process. The response information processing module is configured for collecting response information of the network server, generating an XML document, creating an instance of a user-defined class, assigning element values of the XML document to variables in the instance of the class, and returning values of the variables to the business server.

A computer-based method for requesting a Web service from a network server is also provided. The method includes the steps of: receiving a service request from a user computer; invoking a corresponding Web service from a network server; determining whether the Web service is accessible in the network server; reading configuration information of the Web service if the Web service is accessible; generating a simple object access protocol (SOAP) request according to the configuration information, and sending the SOAP request to the network server for process; collecting response information of the network server, generating an XML document, creating an instance of a user-defined class, assigning element values of the XML document to variables in the instance of the class, and returning values of the variables to a business server.

Other systems, methods, features, and advantages of the present invention will be or become apparent to one with skill in the art upon examination of the following drawings and detailed description.

### BRIEF DESCRIPTION OF THE DRAWINGS

FIG. 1 is a schematic diagram of a hardware configuration of a system for requesting a Web service from a network server in accordance with a preferred embodiment;

FIG. 2 is a schematic diagram showing function modules of a control server of the system of FIG. 1; and

FIG. 3 is a flowchart of a preferred method for requesting a Web service from a network server, in accordance with one embodiment.

### DETAILED DESCRIPTION OF THE INVENTION

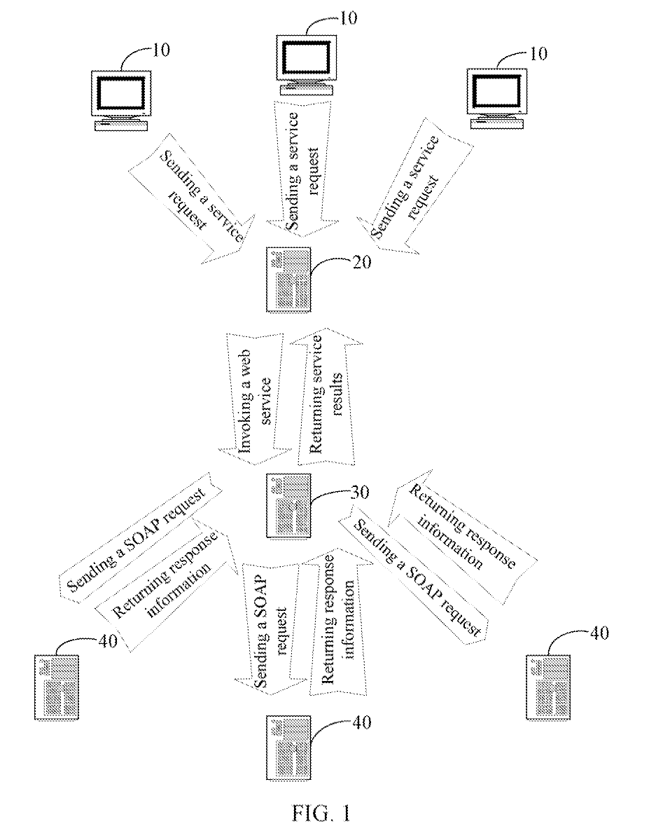

FIG. 1 is a schematic diagram of a hardware configuration of a system for requesting a Web service from a network server (hereinafter, “the system”) in accordance with a preferred embodiment. The system includes one or more user computers 10, a business server 20, a control server 30, and one or more network servers 40. Each of the user computers 10 is associated with one or more specific users. Each of the network servers 40 stores one or more Web services. The Web service can process a service request such as a query request sent by the user computer 10, and generate response information (i.e., query results). Each of the Web services has an identifier. The business server 20 is configured for receiving the service request from the user computer 10 and invoking a corresponding Web service from the network server 40.

The control server 30 is configured for detecting whether the Web service is accessible in the network server 40, reading configuration information of the Web service if the Web service is accessible, generating a simple object access protocol (SOAP) request according to the configuration information, sending the SOAP request to the network server 40 for process, collecting the response information of the network server 40, generating processing results in the format of an XML document, creating an instance (i.e., an object) of a user-defined class, assigning element values of the XML document to variables in the instance of the class, and returning values of the variables to the business server 20.

The configuration information includes a Web service address (i.e., the network server 40 that stores the Web service). When the Web service information such as the Web service address changes, only the configuration information of the Web service needs to be updated.

The user computers 10 are configured for users to send the service request to the business server 20. The embodiment can be illustrated by an example as follows. When the business server 20 receives the service request from the user computer 10, the business server 20 invokes the corresponding Web service from the network server 40, and transfers the service request to the control server 30. The control server 30 determines whether the Web service is accessible (i.e., whether the Web service identifier exist) in the network server 40, reads the configuration information of the Web service if the Web service is accessible, generates the simple object access protocol (SOAP) request according to the configuration information, and sends the SOAP request to the network server 40.

When the network server 40 receives the SOAP request, it invokes the Web service to process the SOAP request, and returns the response information to the control server 30. The control server 30 generates the XML document, creates the instance of the user-defined class, assigns the element values of the XML document to variables in the instance of the class, and returns the values of the variables to the business server 20. The business server 20 returns the values of the variables as the service results to the user computer 10.

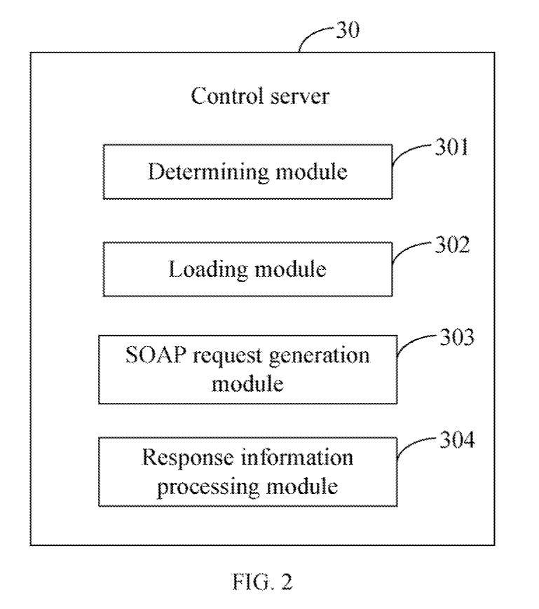

FIG. 2 is a schematic diagram showing function modules of the control server 30. From a functional point of view, the control server 30 may include a determining module 301, a loading module 302, a SOAP request generation module 303, and a response information processing module 304.

The determining module 301 is configured (i.e., structured and arranged) for determining whether the Web service is accessible in the network server 40. The Web service can be invoked by the business server 20 when the user computer 10 sends the service request to the business server 20. The loading module 302 is configured for reading the configuration information of the Web service if the Web service is accessible. The configuration information includes the Web service address. The Web service address is the network server 40 that stores the Web service.

The SOAP request generation module 303 is configured for generating the SOAP request according to the configuration information, and sending the SOAP request to the network server 40 for process. The network server 40 used to process the SOAP request is determined by the Web service address in the configuration information of the Web service. When the network server 40 receives the SOAP request, the network server 40 invokes the Web service to process the SOAP request and returns the response information to the control server 30.

The response information processing module 304 is configured for collecting the response information of the network server 40, generating an XML document, creating an instance of the user-defined class, traversing the XML document, assigning the element values of the XML document to variables in the instance of the class, and returning the values of the variables to the business server 20.

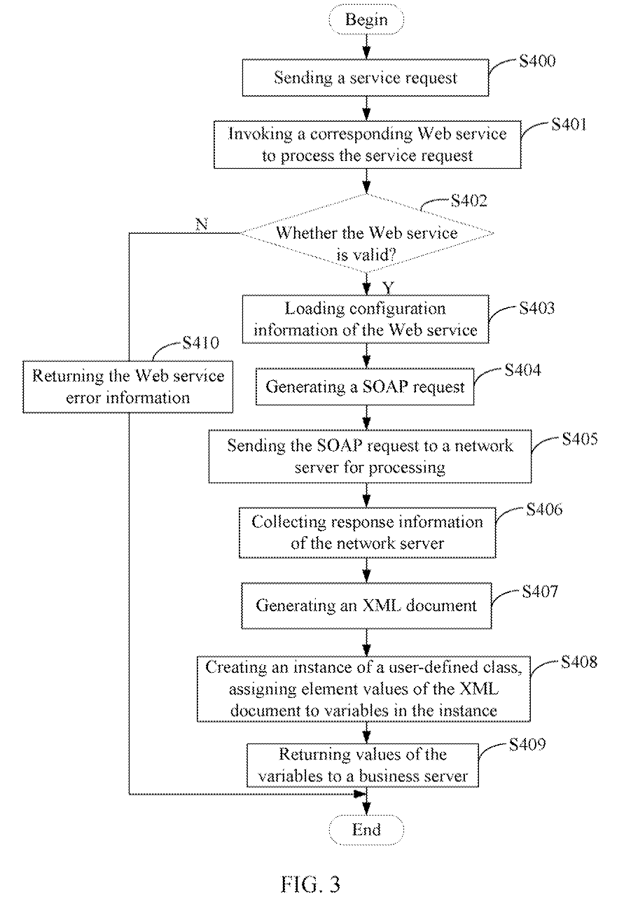

FIG. 3 is a flowchart of the preferred method for requesting the Web service from the network server. In step S400, the user computer 10 sends the service request to the business server 20.

In step S401, the business server 20 invokes the corresponding Web service from the network server 40 to process the service request, and transfers the service request to the control server 30.

In step S402, the determining module 301 determines whether the Web service is accessible in the network 40.

In step S403, the loading module 302 reads the configuration information of the Web service in the control server 30 if the Web service is accessible.

In step S404, the SOAP request generation module 303 generates the SOAP request according to the configuration information.

In step S405, the SOAP request generation module 303 sends the SOAP request to the network server 40 for processing. The network server 40 is determined by the Web service address in the configuration information. When the network server 40 receives the SOAP request, it invokes the Web service to process the SOAP request thereby yielding response information.

In step S406, the response information processing module 304 collects the response information of the network server 40.

In step S407, the response information processing module 304 generating processing results in the format of the XML document according to the response information.

In step S408, the response information processing module 304 creates the instance of the user-defined class, traverses the XML document, and assigns the element values of the XML document to the variables in the instance of the class.

In step S409, the response information processing module 304 returns the values of the variables to the business server 20.

If the Web service is not accessible, in step S410, the determining module 301 returns the Web service error information.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for requesting a Web service from a network server, the system comprising user computers, a business server, a control server, and network servers, the network servers being configured for storing Web services, the business server being configured for receiving a service request from the user computer and invoking a corresponding Web service from the network server, and the control server comprising:
a determining module configured for determining whether the Web service is accessible in the network server;
a loading module configured for reading configuration information of the Web service if the Web service is accessible;
a SOAP request generation module configured for generating a simple object access protocol (SOAP) request according to the configuration information, and sending the SOAP request to the network server for process; and
a response information processing module configured for collecting response information of the network server, generating an XML document, creating an instance of a user-defined class, assigning element values of the XML document to variables in the instance of the class, and returning values of the variables to the business server.

2. The system according to claim 1, wherein the configuration information includes a Web service address representing the network server that stores the Web service.

3. The system according to claim 2, wherein the response information processing module assigning the element values of the XML document to the variables in the class is achieved by traversing the XML document, and assigning the element values of the XML document to the variables in the instance of the user-defined class.

4. A computer-based method for requesting a Web service from a network server, the method comprising the steps of:
receiving a service request from a user computer;
invoking a corresponding Web service from a network server;
determining whether the Web service is accessible in the network server;
reading configuration information of the Web service if the Web service is accessible;
generating a simple object access protocol (SOAP) request according to the configuration information, and sending the SOAP request to the network server for process; and
collecting response information of the network server, generating an XML document, creating an instance of a user-defined class, assigning element values of the XML document to variables in the instance of the class, and returning values of the variables to a business server.

5. The method according to claim 4, wherein the configuration information includes a Web service address representing the network server that stores the Web service.

6. The method according to claim 5, wherein the step of assigning the element values of the XML document to the variables in the class comprises the step of: traversing the XML document, and assigning the element values of the XML document to the variables in the instance of the user-defined class.
